(19) United States
(12) Patent Application Publication
(10) Pub. No.: US 2002/0124905 A1
(43) Pub. Date: Sep. 12, 2002

(54) Multi-dose vial holder

(76) Inventors: David Gardner Draughn, Gastonia, NC (US); Johnny Leonard Herring, Dallas, NC (US)

Correspondence Address: David G. Draughn, 1641 Plantation Trail, Gastonia, NC, 28056, US

(21) Appl. No.: 09/804,450

(22) Filed: Mar. 12, 2001

(51) Int. Cl. B67C 3/00

(52) U.S. Cl. 141/25; 141/329

(57) ABSTRACT

A physical means of support and positioning for multi-dose vials by employing in a preferred embodiment, a specifically designed multi-sided structure whose front side is angled in such a manner as to hold the vial in proper orientation for access, and is shaped in such a manner as to firmly and securely hold vial by it's bottle neck in a closely conforming slot, and whose open anterior area permits visual inspection of vial expiration dates and actual fluid appearance and volume, and whose back provides temporary or permanent attachment to a surface in a position such that visibility of the vial's penetrable multi-dose orifice is optimal and allows access for aspiration or injection of fluid, and whose bottom perimeter is flat and sufficiently broad whereby accidental tipping over of usually cylindrical multi-dose vials and their subsequent displacement is prevented.

### BACKGROUND OF THE INVENTION

1. Technical Field of the Invention

This invention relates generally to aids for insertion of hypodermic needles into multi-dose vials having penetrable caps. In particular, it relates to a means of support for multi-dose vials enabling the user to devote their total efforts into the proper manual insertion of a hypodermic needle or other penetrating device through the penetrable cap of the vials for the purpose of either aspirating from or injecting into the vials without having to simultaneously hold the vial to be penetrated.

2. Background Art

The disadvantages of withdrawing medications from multi-dose vials or injecting fluids into such vials have traditionally been related to the risk of inadvertent needle stick injury to ones self or one's assistant when holding such vial and the non-optimal use of such an assistant's time to simply hold a vial, for example, during performance of a procedure under sterile conditions. Needle stick injury is prohibitively costly in that; documentation is burdensome in administrative time; treatment and liability costs for potential disease transmission are enormous; and, the use of highly skilled and trained medical assistants to hold such vials is an inefficient use of their time and therefore costly in relation to payroll expense.

Although the invention is primarily useful in withdrawing medication from multi-dose vials, the injection of a second fluid, such as saline for drug reconstitution or body fluids for culturing, also has inherent risks of inadvertent needle sticks and this device is equally well suited at securely positioning vials in those circumstances.

Additional disadvantages of multi-dose vials used for administration of medications such as insulin, are the vials small size and cylindrical shape, leading to difficulty of manipulation during use and accidental tip-over in the storage condition.

A population of multi-dose vial users who may have additional degrees of risk are Diabetics due to possible diminished visual capacity, diminished sense of touch associated with peripheral neuropathy, mental status alterations associated with hyper- and/or hypo-glycemia. Another population at risk of incapacity to overcome the difficulties associated with the traditional methods of using a multi-dose vial is persons of advanced age with the additional co-morbidities of arthritis, peripheral vascular disease, neuro-muscular disease, and heart disease. The difficulty of these individuals using such a vial is greatly under-appreciated and under-reported. For these patients, inherent susceptibility due to their diminished capability to easily see, manipulate, puncture, and aspirate the vial without inadvertent injury is noteworthy. Moving supplies to a secondary area where they may feel more stable may also be unduly burdensome.

As will be appreciated by those skilled in the art, a device which would securely position vials so that inspection of the expiration date and contents of the vial can be easily accomplished while allowing the user to either manually aspirate from or inject into it by use of a hypodermic needle without concern for injury of self or others would be a substantial improvement over the prior art of total manual manipulation, due to the risks of injury, or the prior art of other totally or partially mechanical devices, due to prohibitive costs, failure of moving parts, and complexity of use.

Such a device as we propose would also stabilize the vial(s) during storage, allow permanent or temporary attachment in a position best suited for aspiration or injection, and allow accurate localization of the penetrable cap.

Furthermore, such a device would be appreciated in environments where administration of medications such as local anesthetics in physicians procedure rooms, dental offices, veterinary offices, emergency rooms, operating rooms, dialysis centers, and wound care centers requires the use of an assistant to hold the multi-dose vial suspended and inverted for access due to the healthcare professional having to maintain a sterile environment. Non-institutional use in the home environment for such populations as diabetics and elderly may well reduce not only the injury rate from inadvertent needle sticks, but also may decrease the reliance on assistance from secondary parties such as home health agencies or family members. Diabetics being able to administer their own medications reliably on a scheduled basis without delay due to the untimely arrival of assistance may reduce the overall long term morbidity of unchecked hyperglycemia, may reduce the number of emergency room admissions due to inaccurate administration of insulin by those attempting independent use of such vials in an state of diminished capacity.

These are just a few of the many circumstances that would make such a device desirable to a large variety of the total population including skilled healthcare professionals and personal consumers, who may be less able to develop the skills necessary to manipulate the vials and syringes in a totally unassisted manner or less eager to purchase more costly and complicated devices.

In the past, there have been numerous devices adapted specifically for securing vials for insertion of hypodermic needles. These inventions include those disclosed in the references to Gross, et al., U.S. Pat. No. 6,186,982; Perez, et al., U.S. Pat. No. 6,159,184; Dobbins, U.S. Pat. No. 3,907,009; Geringer, U.S. Pat. No. 6,162,199; Ethington, U.S. Pat. No. 4,018,223; King, et al., U.S. Pat. No. 6,090,082; Right, U.S. Pat. No. 4,219,055; Maaki, U.S. Pat. No. 4,252,159; LaDow, U.S. Pat. No. 4,778,454; Bloom, et al., U.S. Pat. No. 4,098,276; Strong, U.S. Pat. No. 4,883,101; Lee, U.S. Pat. No. 4,274,453; Walldbauer, Jr. et al., U.S. Pat. No. 3,833,030 French, GB Pat. No. 1,179,888; and Schraga, U.S. Pat. No. 5,697,916.

While various desirable objectives and useful features are dispersed throughout this and other prior art, including various brackets for holding vials and syringes, electronic displays of dosage amounts, and selectable or positionable levers for setting dosage amounts; nowhere is there known to be disclosed, illustrated, or suggested, a device specifically designed for the purpose of holding a multi-dose vial securely at a preferred angle to allow for manual penetration of the vial's penetrable cap and ensuing aspiration of it's contents.

### BRIEF SUMMARY OF THE INVENTION

The invention is fundamentally a device for assisting in the manual aspiration from or injection into vials with penetrable caps. Different embodiments incorporate various novel combinations of features to satisfy the various objectives of the invention. For example, it is an object of the invention to provide a stable and secure method of holding vials in such a position as to allow the manual insertion of a needle or other penetrating device into the penetrable caps so as to allow the user the free use of both hands to perform that task as well as manipulation of the plunger of an attached syringe thereby preventing an inadvertent needle prick to the user or their assistants.

It is also an object of the invention to hold vials in such a manner as to promote total evacuation of the contents upon aspiration thereof It is a further object of the invention to allow the user to readily view the expiration date of the vials as well as the condition and volume of the contents without removal from the invention. It is yet a further object to allow for securing multiple vials of a larger size in either an upright or inverted position for various reasons. It is still yet another object of the invention to secure the vials from tipping while in a storage device such as a refrigerator.

In a preferred embodiment of the invention, the front, proximal, or anterior side is configured for easy insertion and removal and secure positioning of multi-dose vials in closely conforming slots. In an alternate embodiment such slots may be modified so as to receive a sizing grommet to accommodate variously sized vial necks.

The back, distal, or posterior side of the device is configured to accept various mounting options such as: adhesive backing for permanent mounting, magnetic backing for temporary mounting to surfaces having a sufficient iron content, and holes for permanent mounting by utilization of wall anchors or permanent mounting to an indexing plate used to variably choose either upright or inverted positioning. The top or superior area is open to facilitate insertion of multi-dose vials and viewing of the vials' expiration dates and contents. The bottom or inferior perimeter is of a sufficiently common plane, breadth, and depth to support the vials securely during a storage. Although open in the preferred embodiment, a closed surface may also be employed in an alternate embodiment. There is incorporated into one embodiment of the invention, a separate mounting plate to allow for 180 degree indexing of the invention's mounting position.

Still other objects and advantages of the present invention will become evident to those skilled in the art from the following detailed description, wherein we have shown and described only the preferred embodiments of the invention, simply by way of illustration of the modes contemplated by us upon carrying our out invention. As will be realized, the invention is capable of other and different embodiments, and it's several details are capable of sustaining various modifications in various respects, none of which depart from the utilization field of the invention.

### BRIEF DESCRIPTION OF THE SEVERAL VIEWS OF THE DRAWING

FIG. 1 is a perspective view of a first embodiment of the invention in the unloaded condition with the vial and syringe displaced.

FIG. 2 is a perspective view of the embodiment of FIG. 1 in the loaded condition with the vial emplaced and the syringe displaced.

FIG. 3 is a perspective view of the embodiment of FIG. 1 in the loaded condition with the vial and syringe emplaced.

FIG. 4 is a perspective view of the embodiment of FIG. 1, showing the back of the distal side and the permanent or temporary mounting options.

FIG. 5 is a perspective view of a second embodiment having a larger size and a plurality of larger slots (3 shown here) to accommodate multiple larger vials, shown in the loaded condition with one vial emplaced.

FIG. 6 is a perspective view of the embodiment of FIG. 5 mounted to an auxiliary mounting plate (not visible in this view) which allows 180 degree indexing of position. (shown here in the inverted position)

FIG. 7 is a perspective view of the embodiment of FIG. 5 showing the back or distal side for a clear view of all three mounting holes.

FIG. 8 is a perspective view of the embodiment of the auxiliary mounting plate mentioned but not visible in FIG. 6

### DETAILED DESCRIPTION OF THE INVENTION

As will be readily appreciated by those skilled in the art, the multi-dose vial holder will support the vial in such a manner as to allow easy access to the penetrable cap and thus allowing the user to concentrate their total efforts into manipulation of a needle or other penetrating device into the cap and the ensuing syringe plunger manipulation. Furthermore, the multi-dose vial holder will allow this to be accomplished in a variety of positions to accommodate eye level use or, by incorporation of the auxiliary mounting plate, inverted use for vial filling.

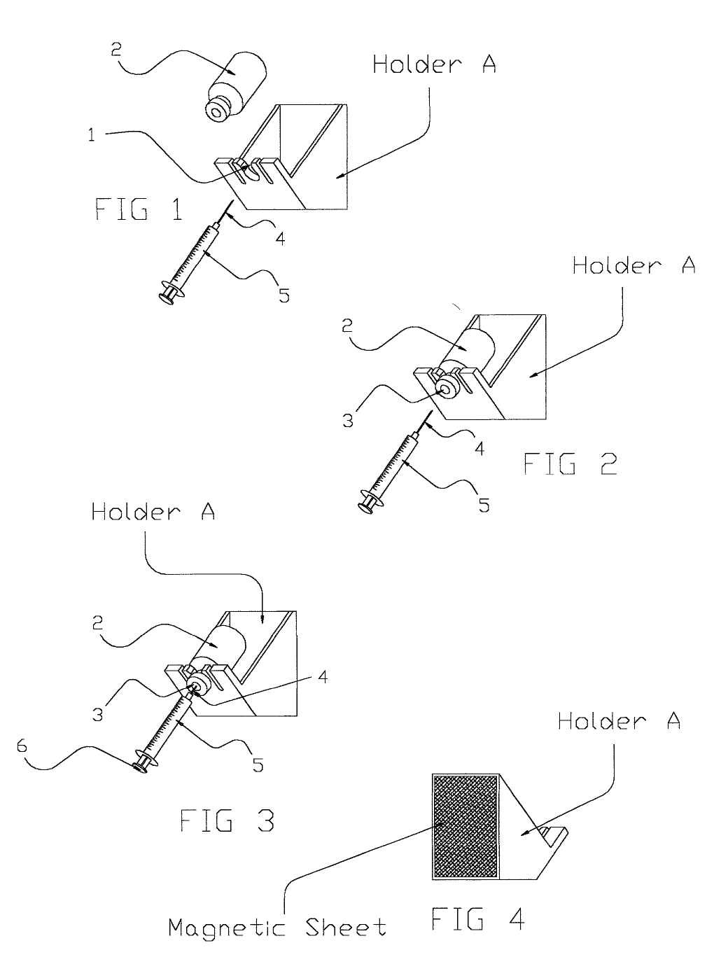

Thus referring to the drawings, specifically FIG. 1 through FIG. 4, a multi-dose vial 2, henceforth called “the vial” is loaded into the closely conforming slot 1 of the first embodiment A, of the multi-dose vial holder, henceforth called “Holder A” by the neck area of it's body as shown in FIG. 2. Securing the vial in this manner prevents slippage in either axial direction during insertion or withdrawal of a needle 4. Now the user may manually insert the needle portion 4 of syringe assembly into the penetrable cap 3 of the vial 2 using both hands if desired. This position is shown in FIG. 3. At this point the user can support the syringe body 5 with one hand while manipulating the syringe plunger 6 with the other hand. Not having to be concerned with supporting the vial 2, either before, during, or after the aspiration of fluid from or injection of fluid into the vial, while having to manipulate the syringe assembly, allows the user more freedom to accurately puncture the penetrable cap 3 and properly manipulate the stroke of the plunger 6. A magnetic sheet, as shown in FIG. 4, attached to the back of the distal side of “Holder A” allows the user to temporarily attach “Holder A” to metal surfaces at a convenient level for use.

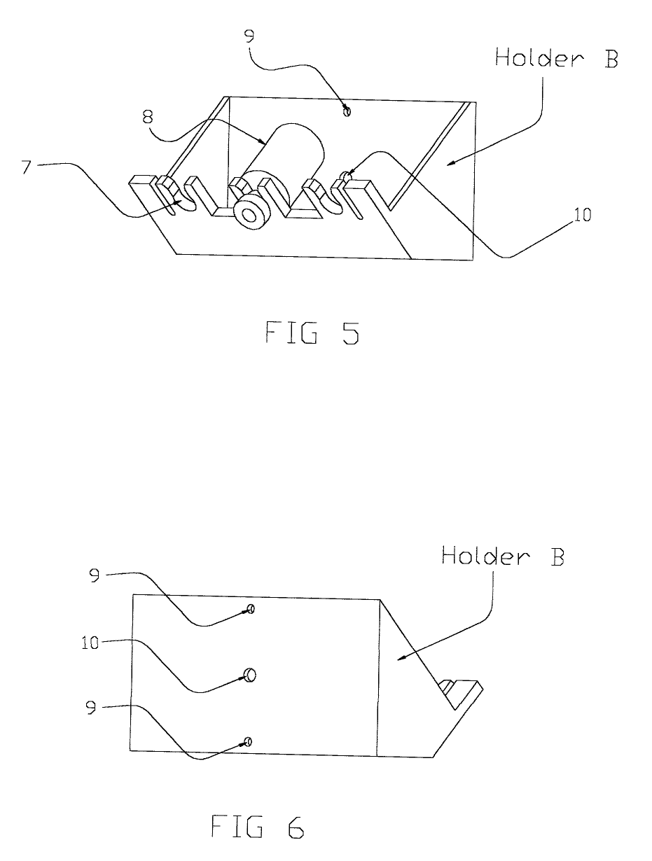

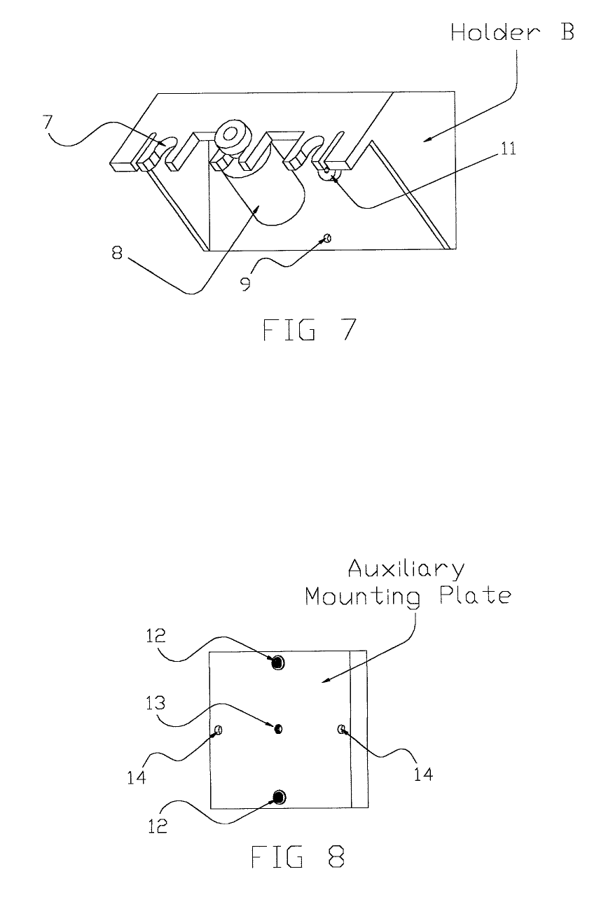

Now referring to FIG. 5., the second embodiment B of the multi-dose vial holder, henceforth called “Holder B”, will accommodate multiple larger vials 8 by means of a plurality of larger closely conforming slots 7 and a larger overall size. The loading of, and use of “Holder B”, will be the same as that of “Holder A” except that it may be done in plurality if the user so chooses. The mounting of “Holder B” will, however, be accomplished in a different manner, either by means of utilizing wall anchors through a set of holes 9 located in it's distal side, or by means of utilizing a shoulder screw 11 through hole 10 into the Auxiliary Mounting Plate shown in FIG. 8.

Referring lastly to FIG. 8., the Auxiliary Mounting Plate, henceforth called the “Mounting Plate”, should be mounted onto surfaces by utilizing flat head wall anchors through holes 14 thus allowing the mounting of “Holder B” to it by inserting a shoulder screw 11 through hole 10 and subsequently threading screw 11 into hole 13. Spring-loaded ball plungers 12 of sufficient size and strength to lock “Holder B” into position when affixed to the “Mounting Plate” are inserted into the “Mounting Plate” at a position vertically aligned with hole 13 so as to coincide with holes 9 in “Holder B” when it is mounted to the Mounting Plate. The ball plungers 12 will allow indexing of the “Holder B” to either a upright (FIG. 5) or inverted (FIG. 6) position by manually pivoting the “Holder B” on the shoulder screw 11 until the ball plungers 12 interface with either hole 9 in “Holder B”.

The objects and advantages of the invention may be realized and attained by means of the intrumentalities and combinations particularly pointed out in the appended claims while additional objects and advantages may be realized by actual employment of this invention by those skilled in the art. Accordingly, the objects, drawings, and descriptions are to be regarded as illustrative in nature, and not as restrictive.

We claim:

1. A multi-dose vial holding apparatus for holding and positioning said vials, comprising a multi-sided support frame having, but not limited to, front, rear, right, and left sides, and a top and bottom perimeter.

2. The apparatus of claim 1, wherein said right and left sides having such a relationship to said front and rear sides as to form a stable structure fixing said front side to said rear side.

3. The apparatus of claim 1, wherein said front side has either a single or plurality of notched areas.

4. The apparatus of claim 1, wherein said notches in said front side, being of such a size and shape as to allow for easy insertion of said vials or, alternatively, vial size adapters, and to securely hold yet readily release upon demand said vials by their neck while apparatus of claim 1 is placed in various positions.

5. The apparatus of claim 1, wherein said top perimeter is of a sufficiently open nature so as to permit easy access to said notched areas for insertion of said vials or said vial size adapters and viewing the contents of said vials.

6. The apparatus of claim 1, wherein said front side being at a preferred angle in relation to said bottom perimeter and said rear side.

7. The apparatus of claim 1, wherein said front side of which being of said angle and therefore securely holding said vials at such angle that ease of manual insertion of a hypodermic needle or other penetrating device into the penetrable cap of said vials is facilitated, whether the apparatus of claim one is mounted in an upright or inverted position.

8. The apparatus of claim 1, wherein said front side of which being of said angle and therefore securely holding said vials at such angle that evacuation of the total contents of said vials upon the aspiration thereof is facilitated when the apparatus of claim 1 is mounted in said upright position.

9. The apparatus of claim 1, wherein said front side of which being of said angle and therefore securely holding said vials at such an angle that proper filling of said vials with fluids is facilitated when the apparatus of claim 1 is mounted in said inverted position.

10. The apparatus of claim 1, wherein said rear side being provided with various options for mounting to various surfaces in various positions, either temporarily or permanently.

11. The apparatus of claim 1, wherein said front, rear, left, and right sides join at said bottom perimeter on a sufficiently common plane to form a stable base for storage of said vials while remaining in the apparatus of claim 1 during a period of storage or when the apparatus of claim 1 may not be mounted to any surface.

12. A mounting plate employing spring loaded devices and a single pivot mounting screw to facilitate secure optional positioning of the apparatus of claim 1 with a minimum of effort while not compromising the mounting integrity of the apparatus of claim 1 or the apparatus of claim 12.
